(19) United States
(12) Patent Application Publication
(10) Pub. No.: US 2025/0367947 A1
(43) Pub. Date: Dec. 4, 2025

(54) MEDIUM EJECTING APPARATUS, MEDIUM EJECTING METHOD, AND COMPUTER-READABLE NON-TRANSITORY RECORDING MEDIUM

(71) Applicant: PFU LIMITED, Kahoku-shi (JP)

(72) Inventor: Takayuki Umi, Kahoku-shi (JP)

(21) Appl. No.: 19/219,456

(22) Filed: May 27, 2025

(30) Foreign Application Priority Data
May 29, 2024 (JP) 2024-087099

(51) Int. Cl. B41J 13/00; B41J 11/00; B41J 13/10; H04N 1/00

(52) U.S. Cl. CPC B41J 13/0036; B41J 11/003; B41J 11/0095; B41J 13/106; H04N 1/00602; H04N 1/00631

(57) ABSTRACT

A medium ejecting apparatus includes a conveyance roller to convey a medium, a processing device to perform a predetermined processing relative to the medium conveyed by the conveyance roller, an ejection roller located downstream from the processing device in a medium ejecting direction to eject the medium subjected to the predetermined processing, a motor to drive the conveyance roller and the ejection roller, a first media sensor located between the conveyance roller and the processing device to detect the medium, and circuitry. The circuitry detects a skew amount of the medium, and controls the ejection roller based on a detection result by the first media sensor and the skew amount before a trailing end of the medium passes the ejection roller.

### CROSS-REFERENCE TO RELATED APPLICATIONS

This patent application is based on and claims priority pursuant to 35 U.S.C. § 119(a) to Japanese Patent Application No. 2024-087099, filed on May 29, 2024, in the Japan Patent Office, the entire disclosure of which is hereby incorporated by reference herein.

### BACKGROUND

The present disclosure relates to a medium ejecting apparatus, a medium ejecting method, and a computer-readable non-transitory recording medium.

A medium ejecting apparatus such as a scanner or a printer performs predetermined processing such as imaging of a medium or image formation on a medium while sequentially conveying media, and ejects the media onto an ejection tray. In such a medium ejecting apparatus, when the media ejected onto the ejection tray are not aligned, the user has to align the media. By contrast, in the medium ejecting apparatus, when the ejection speed (conveyance speed) of the media is changed to align the media ejected onto the ejection tray, the intervals of imaging positions or image formation positions on one medium may vary. This may distort an image in which the medium is imaged or an image formed on the medium.

There is a document reading apparatus that detects the skew amount of a document with a document sensor and controls the relation between the conveyance speed of a conveyance roller pair and the speed of an ejection roller pair according to the skew amount.

### SUMMARY

The medium ejecting apparatus according to one aspect of the present disclosure includes a conveyance roller to convey a medium, a processing device to perform a predetermined processing relative to the medium conveyed by the conveyance roller, an ejection roller located downstream from the processing device in a medium ejecting direction to eject the medium subjected to the predetermined processing, a motor to drive the conveyance roller and the ejection roller, a first media sensor located between the conveyance roller and the processing device to detect the medium, and circuitry. The circuitry detects a skew amount of the medium, and controls the ejection roller based on a detection result by the first media sensor and the skew amount before a trailing end of the medium passes the ejection roller.

The method according to another aspect of the present disclosure includes driving a conveyance roller and an ejection roller with a motor; conveying a medium by the conveyance roller; detecting the medium by a media sensor located between the conveyance roller and a processing device that performs predetermined processing relative to the medium conveyed by the conveyance roller; detecting a skew amount of the medium; controlling the ejection roller based on a detection result of the medium and the skew amount before a trailing end of the medium passes the ejection roller; and ejecting, by the ejection roller, the medium subjected to the predetermined processing. The ejection roller is located downstream from the processing device in a medium ejecting direction

The computer-readable, non-transitory recording medium according to still another aspect of the present disclosure stores a computer program that causes a medium ejecting apparatus to perform a process. The medium ejecting apparatus includes a conveyance roller to convey a medium, a processing device to perform predetermined processing relative to the medium, an ejection roller located downstream from the processing device in a medium ejecting direction to eject the medium subjected to the predetermined processing, a motor to drive the conveyance roller and the ejection roller, and a media sensor located between the conveyance roller and the processing device to detect the medium. The process includes detecting a skew amount of the medium, and controlling the ejection roller based on a detection result of the medium and the skew amount before a trailing end of the medium passes the ejection roller.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium ejecting apparatus according to an embodiment;

FIG. 2 is a diagram illustrating a medium conveying path inside the medium ejecting apparatus illustrated in FIG. 1;

FIG. 3 is a schematic diagram illustrating the positions of media sensors of the medium ejecting apparatus illustrated in FIG. 1;

FIG. 4 is a block diagram illustrating a schematic configuration of the medium ejecting apparatus illustrated in FIG. 1;

FIG. 5 is a block diagram illustrating a schematic configuration of a memory and a processing circuit illustrated in FIG. 4;

FIG. 6 is a flowchart of a medium conveying process according to an embodiment;

FIG. 7 is a flowchart of the medium conveying process and the continuation of FIG. 6;

FIG. 8 is a graph for explaining changes in the speeds of a feed roller and a conveyance roller of the medium ejecting apparatus illustrated in FIG. 1;

FIG. 9 is a graph for explaining changes in the speeds of the feed roller and the conveyance roller of the medium ejecting apparatus illustrated in FIG. 1;

FIG. 10 is a flowchart of an ejection control process according to an embodiment;

FIG. 11 is a graph for explaining changes in the speeds of the feed roller and the conveyance roller of the medium ejecting apparatus illustrated in FIG. 1;

FIG. 12 is a graph for explaining changes in the speeds of the feed roller and the conveyance roller of the medium ejecting apparatus illustrated in FIG. 1;

FIG. 13 is a diagram illustrating a medium conveying path inside a medium ejecting apparatus according to another embodiment; and

FIG. 14 is a diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, a medium ejecting apparatus, a medium ejecting method, and a control program according to embodiments of the present disclosure are described below. The technical scope of the present disclosure is not limited to the embodiments described below and covers equivalents of elements described below. As used herein, the singular forms “a,” “an,” and “the” are intended to include the plural forms as well, unless the context clearly indicates otherwise.

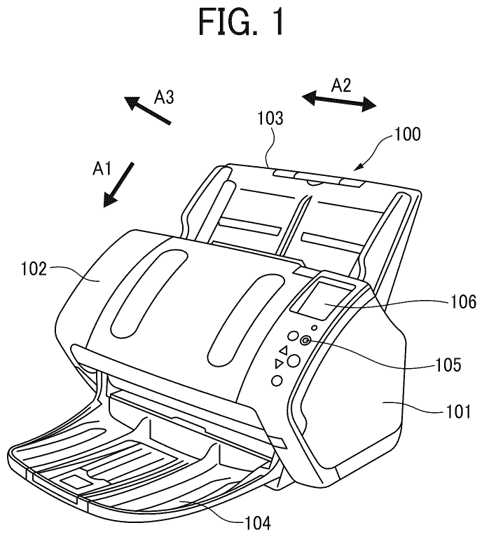

FIG. 1 is a perspective view of a medium ejecting apparatus 100 that is an image scanner.

The medium ejecting apparatus 100 conveys, images, and ejects media that are documents. Examples of the media include paper, thick paper, cards, booklets, and passports. Alternatively, the medium ejecting apparatus 100 may be a facsimile machine, a copier, a multifunction peripheral (MFP), or the like. The media to be conveyed may be printing material (e.g., paper sheets) instead of documents, and the medium ejecting apparatus 100 may be a printer to form an images on a medium conveyed.

In FIG. 1, arrow A1 indicates the direction in which media are ejected, which may be referred to as a “medium ejecting direction A1” in the following description. Arrow A2 indicates the width direction perpendicular to the medium ejecting direction A1, and arrow A3 indicates the height direction perpendicular to a medium conveying path. These directions may be referred to as a “width direction A2” and a “height direction,” respectively, in the following description. In the following description, the term “upstream” refers to upstream in the medium ejecting direction A1, and the term “downstream” refers to downstream in the medium ejecting direction A1. The width direction A2 is an example of a direction intersecting the medium ejecting direction.

The medium ejecting apparatus 100 includes a lower housing 101, an upper housing 102, a media tray 103, an ejection tray 104, an operation device 105, and a display device 106.

The upper housing 102 is located to cover the upper surface of the medium ejecting apparatus 100 and is hinged to the lower housing 101 such that the upper housing 102 can be opened and closed to allow, for example, removal of a jammed medium or cleaning of the inside of the medium ejecting apparatus 100.

The media tray 103 is engaged with the lower housing 101. Media to be fed and conveyed are placed on the media tray 103. The ejection tray 104 is engaged with the upper housing 102, and the ejected media are stacked thereon. The ejection tray 104 may be engaged with the lower housing 101.

The operation device 105 includes an input device such as a button and an interface circuit that receives signals from the input device. The operation device 105 receives an input operation performed by a user and outputs an operation signal corresponding to the input operation performed by the user. The display device 106 includes a display and an interface circuit that outputs image data to the display, and displays the image data on the display. Examples of the display include a liquid crystal display and an organic electro-luminescence (EL) display.

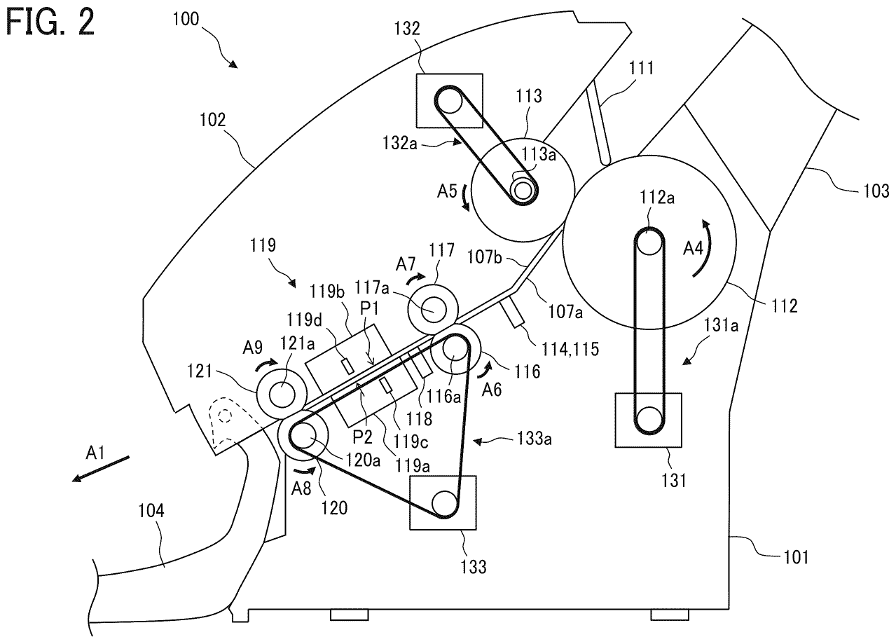

FIG. 2 is a diagram illustrating the medium conveying path inside the medium ejecting apparatus 100.

The medium ejecting apparatus 100 includes a first media sensor 111, a feed roller 112, a separation roller 113, a second media sensor 114, a third media sensor 115, a conveyance roller 116, a first facing roller 117, a fourth media sensor 118, an imaging device 119 including an imaging sensor, an ejection roller 120, and a second facing roller 121, which are located along the medium conveying path.

The number of the feed roller 112, the separation roller 113, the conveyance roller 116, the first facing roller 117, the ejection roller 120, and/or the second facing roller 121 is not limited to one but may be two or more. When the feed roller 112, the separation roller 113, the conveyance roller 116, the first facing roller 117, the ejection roller 120, and/or the second facing roller 121 are formed of multiple rollers, the multiple rollers are located at intervals in the width direction A2.

The upper face of the lower housing 101 forms a lower guide 107a for the medium conveying path, and the lower face of the upper housing 102 forms an upper guide 107b for the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104. Since the medium conveying path is a straight path, the medium ejecting apparatus 100 is compact.

The first media sensor 111 is located upstream from the feed roller 112 and the separation roller 113. The first media sensor 111 includes a contact sensor and detects whether a medium is placed on the media tray 103. The first media sensor 111 generates and outputs a first media signal whose signal value changes depending on whether a medium is placed on the media tray 103. The first media sensor 111 is not limited to a contact sensor. The first media sensor 111 may be any other sensor such as an optical detection sensor that detects the presence of a medium.

The feed roller 112 is in the lower housing 101, separates the media on the media tray 103 one by one from the bottom, and sequentially feeds the media. The feed roller 112 is an example of a conveyance roller. The separation roller 113 is a so-called brake roller or retard roller, located in the upper housing 102, and faces the feed roller 112. The separation roller 113 is rotatable in the direction indicated by arrow A5 opposite to the rotation direction for conveying the media (may be referred to as a medium feeding direction in the following description). Alternatively, the separation roller 113 is stoppable. Instead of the separation roller 113, a separation pad may be used.

The conveyance roller 116 and the first facing roller 117 are located downstream from the feed roller 112 and the separation roller 113 in the medium ejecting direction A1 and face each other. The conveyance roller 116 and the first facing roller 117 convey the medium fed by the feed roller 112 and the separation roller 113 to the imaging device 119.

The imaging device 119 is an example of a processing device and performs predetermined processing relative to the medium conveyed by the conveyance roller 116. The imaging device 119 images the medium conveyed by the conveyance roller 116 as a predetermined processing. The imaging device 119 includes a first imaging device 119a and a second imaging device 119b facing each other across the medium conveying path.

The first imaging device 119a includes a first imaging sensor 119c that is a unity-magnification contact image sensor (CIS). The CIS includes complementary metal oxide semiconductor (CMOS) imaging elements aligned linearly in the main scanning direction. The first imaging sensor 119c images the front side of a medium at a first imaging position P1. The first imaging device 119a further includes a lens that forms an image on the imaging elements and an analog-to-digital (A/D) converter. The A/D converter amplifies the electrical signals output from the imaging elements and performs analog-to-digital (A/D) conversion. The first imaging device 119a images the front side of each of conveyed media at regular intervals to successively generate and output line images. Specifically, the first imaging device 119a images an area of the conveyed medium facing the first imaging sensor 119c. In other words, the line image has one pixel in the vertical direction (sub-scanning direction) and has multiple pixels in the horizontal direction (main scanning direction).

Similarly, the second imaging device 119b includes a second imaging sensor 119d that is a unity-magnification CIS including CMOS imaging elements located linearly in the main scanning direction. The second imaging sensor 119d images the back side of the medium at a second imaging position P2, which is located downstream from the first imaging position P1 in the medium ejecting direction A1. The second imaging device 119b further includes a lens that forms an image on the imaging elements and an A/D converter. The A/D converter amplifies the electrical signals output from the imaging elements and performs A/D conversion. The second imaging device 119b images the back side of each of conveyed media at regular intervals to successively generate and output line images. Specifically, the second imaging device 119b images an area of the conveyed medium facing the second imaging sensor 119d.

The medium ejecting apparatus 100 may include only one of the first imaging device 119a and the second imaging device 119b to read only one side of the medium. Further, the first imaging sensor 119c and/or the second imaging sensor 119d may be a line sensor that adopts a unity-magnification CIS including charge-coupled device (CCD) imaging elements. Alternatively, the first imaging sensor 119c and/or the second imaging sensor 119d may be a reduction-optical line sensor including CMOS or CCD imaging elements. In the medium ejecting direction A1, the second imaging position P2 of the second imaging sensor 119d may be the same as the first imaging position P1 of the first imaging sensor 119c or upstream from the first imaging position P1.

The ejection roller 120 and the second facing roller 121 are located downstream from the imaging device 119 in the medium ejecting direction A1 and face each other. The ejection roller 120 and the second facing roller 121 eject the medium conveyed by the conveyance roller 116 and the first facing roller 117 and imaged by the imaging device 119 (i.e., subjected to the predetermined processing) to the ejection tray 104. The roller pair located downstream from the imaging device 119 in the medium ejecting direction A1 is only the pair of the ejection roller 120 and the second facing roller 121. The distance between the conveyance roller 116 located upstream from the imaging device 119 and the ejection roller 120 located extreme downstream in the medium ejecting direction A1 is shorter than the minimum medium length supported by the medium ejecting apparatus 100. This structure can reduce the size of the medium ejecting apparatus 100.

The media placed on the media tray 103 are conveyed between the lower guide 107a and the upper guide 107b in the medium ejecting direction A1 as the feed roller 112 rotates in the direction indicated by arrow A4 in FIG. 2, which is the medium feeding direction. The separation roller 113 rotates in the direction indicated by arrow A5 opposite to the medium feeding direction when conveying the medium. When multiple media are placed on the media tray 103, only the medium in contact with the feed roller 112 is separated from the rest of the media on the media tray 103 due to the action of the feed roller 112 and the separation roller 113. This operation prevents the feeding of a medium other than the separated medium (prevention of multi-feed).

The medium is fed between the conveyance roller 116 and the first facing roller 117 while being guided by the lower guide 107a and the upper guide 107b. The medium is then fed between the first imaging device 119a and the second imaging device 119b by the conveyance roller 116 and the first facing roller 117 rotating in the directions indicated by arrows A6 and A7 in FIG. 2, respectively. The medium read by the imaging device 119 is ejected onto the ejection tray 104 by the ejection roller 120 and the second facing roller 121 rotating in the directions indicated by arrows A8 and A9 in FIG. 2, respectively. The media ejected by the ejection roller 120 and the second facing roller 121 are stacked on the ejection tray 104.

As illustrated in FIG. 2, the medium ejecting apparatus 100 includes a first motor 131, a second motor 132, and a third motor 133 as driving sources of the rollers.

The first motor 131 is located in the lower housing 101 and is coupled to the feed roller 112 via a first transmission assembly 131a. The first motor 131 drives the feed roller 112. The first motor 131 generates a driving force to rotate the feed roller 112 to feed a medium according to a control signal from the processing circuit. Alternatively, the first motor 131 may be located in the upper housing 102. The first transmission assembly 131a includes one or more pulleys, belts, and gears between the first motor 131 and a shaft 112a that is the rotation shaft of the feed roller 112. The first transmission assembly 131a transmits the driving force generated by the first motor 131 to the feed roller 112.

The second motor 132 is located in the upper housing 102 separately from the first motor 131. The second motor 132 is coupled to the separation roller 113 via a second transmission assembly 132a and drives the separation roller 113. The second motor 132 generates a driving force to rotate the separation roller 113 according to a control signal from the processing circuit such that the separation roller 113 separates, feeds, and conveys a medium. Alternatively, the second motor 132 may be located in the lower housing 101. The second transmission assembly 132a includes one or more pulleys, belts, and gears between the second motor 132 and a shaft 113a that is the rotation shaft of the separation roller 113. The second transmission assembly 132a transmits the driving force generated by the second motor 132 to the separation roller 113.

The third motor 133 is an example of a motor. The third motor 133 is located in the lower housing 101 separately from the first motor 131 and the second motor 132. The third motor 133 is coupled to the conveyance roller 116 and the ejection roller 120 via a third transmission assembly 133a and drives the conveyance roller 116 and the ejection roller 120. The third motor 133 generates a driving force to rotate the conveyance roller 116 and the ejection roller 120 according to a control signal from the processing circuit such that the conveyance roller 116 and the ejection roller 120 convey and eject a medium. Alternatively, the third motor 133 may be located in the upper housing 102. The third transmission assembly 133a includes one or more pulleys, belts, and gears between the third motor 133, a shaft 116a that is the rotation shaft of the conveyance roller 116, and a shaft 120a that is the rotation shaft of the ejection roller 120. The third transmission assembly 133a transmits the driving force generated by the third motor 133 to the conveyance roller 116 and the ejection roller 120.

As described above, the medium ejecting apparatus 100 includes the third motor 133 as a common motor to drive the conveyance roller 116 and the ejection roller 120. This structure can reduce the number of the motors and reduce the cost, size, and weight of the medium ejecting apparatus 100.

The first facing roller 117 is a driven roller rotated by the conveyance roller 116. The second facing roller 121 is a driven roller rotated by the ejection roller 120. Alternatively, the first facing roller 117 and/or the second facing roller 121 may be driven by the driving force from the third motor 133. In this case, one or more gears are further located between the shaft 116a of the conveyance roller 116 and a shaft 117a that is the rotation shaft of the first facing roller 117 and/or between the shaft 120a of the ejection roller 120 and a shaft 121a that is the rotation shaft of the second facing roller 121. The third transmission assembly 133a further transmits the driving force generated by the third motor 133 to the first facing roller 117 and/or the second facing roller 121.

The separation roller 113, the conveyance roller 116, and the ejection roller 120 may be driven by a common motor.

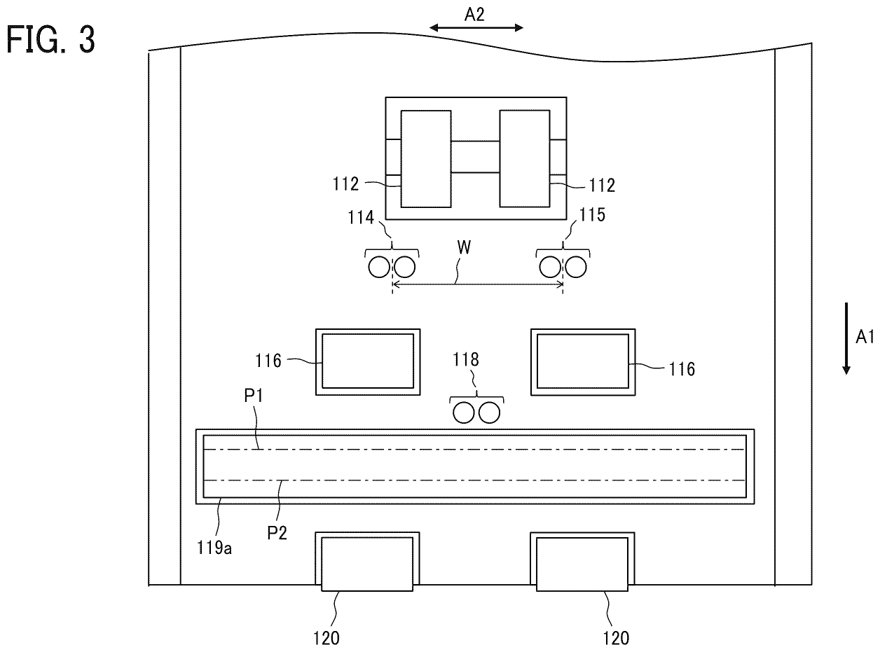

FIG. 3 is a schematic diagram illustrating the positions of the media sensors.

FIG. 3 is a schematic view of the lower housing 101 in an open state as viewed from the medium conveying path. In the example illustrated in FIG. 3, two feed rollers 112, two separation rollers 113, two conveyance rollers 116, two first facing rollers 117, two ejection rollers 120, and two second facing rollers 121 are located.

The second media sensor 114 and the third media sensor 115 are an example of multiple second media sensors. The second media sensor 114 and the third media sensor 115 are located downstream from the feed rollers 112 and the separation rollers 113 and upstream from the imaging device 119 in the medium ejecting direction A1, and are aligned and spaced apart in the width direction A2. The second media sensor 114 and the third media sensor 115 are located such that a distance W between the second media sensor 114 and the third media sensor 115 in the width direction A2 is less than the minimum medium width supported by the medium ejecting apparatus 100. In the example illustrated in FIG. 3, the second media sensor 114 and the third media sensor 115 are located upstream from the conveyance rollers 116 and the first facing rollers 117. Alternatively, the second media sensor 114 and the third media sensor 115 may be located downstream from the conveyance rollers 116 and the first facing rollers 117. The second media sensor 114 and the third media sensor 115 detect the leading end and the trailing end of the medium conveyed to the position of the second media sensor 114 and third media sensor 115.

The second media sensor 114 includes a light emitter, a light receiver, and a light guide. The light emitter and the light receiver are located on one side of the medium conveying path, and the light guide faces the light emitter and the light receiver across the medium conveying path. The light guide is, for example, a U-shaped prism. The light emitter is, for example, a light-emitting diode (LED) and emits light toward the medium conveying path. The light receiver is, for example, a photodiode and receives light emitted from the light emitter and guided by the light guide. When a medium is present at the position facing the second media sensor 114, the light emitted from the light emitter is blocked by the medium, and the light receiver does not detect the light emitted from the light emitter. The light receiver generates and outputs a second media signal based on the intensity of the light received. The second media signal changes in signal value depending on whether a medium is present at the position of the second media sensor 114.

Similarly, the third media sensor 115 includes a light emitter, a light receiver, and a light guide. The light emitter and the light receiver are located on one side of the medium conveying path, and the light guide faces the light emitter and the light receiver across the medium conveying path. The light guide is, for example, a U-shaped prism. The light emitter is, for example, an LED and emits light toward the medium conveying path. The light receiver is, for example, a photodiode and receives light emitted from the light emitter and guided by the light guide. The light receiver generates and outputs a third media signal based on the intensity of the light received. The third media signal changes in signal value depending on whether a medium is present at the position of the third media sensor 115.

The fourth media sensor 118 is an example of a media sensor. The fourth media sensor 118 is located downstream from the feed rollers 112 and the separation rollers 113, in particular, downstream from the conveyance rollers 116 and the first facing rollers 117, and upstream from the imaging device 119 in the medium ejecting direction A1. That is, the fourth media sensor 118 is located between the conveyance rollers 116 and the first facing rollers 117, and the imaging device 119. The fourth media sensor 118 is located at the center in the width direction A2, in particular, between the two conveyance rollers 116 and between the two first facing rollers 117. Alternatively, the fourth media sensor 118 may be located upstream from the conveyance rollers 116 and the first facing rollers 117, in particular, at the same position as the second media sensor 114 and the third media sensor 115 or upstream from the second media sensor 114 and the third media sensor 115 in the medium ejecting direction A1. The fourth media sensor 118 detects the leading end and the trailing end of a medium conveyed to the position of the fourth media sensor 118.

The fourth media sensor 118 includes a light emitter, a light receiver, and a light guide. The light emitter and the light receiver are located on one side of the medium conveying path. The light guide faces the light emitter and the light receiver across the medium conveying path. The light guide is, for example, a U-shaped prism. The light emitter is, for example, an LED and emits light toward the medium conveying path. The light receiver is, for example, a photodiode and receives light emitted from the light emitter and guided by the light guide. The light receiver generates and outputs a fourth media signal based on the intensity of the light received. The fourth media signal changes in signal value depending on whether a medium is present at the position of the fourth media sensor 118.

The second media sensor 114, the third media sensor 115, and/or the fourth media sensor 118 may include a reflector such as a mirror instead of the light guide. The second media sensor 114, the third media sensor 115, and/or the fourth media sensor 118, the light emitter and the light receiver may face each other across the medium conveying path. Further, the second media sensor 114, the third media sensor 115, and/or the fourth media sensor 118 may detect the medium using, for example, a contact sensor that allows a predetermined amount of electrical current to flow when a medium is in contact or not in contact therewith.

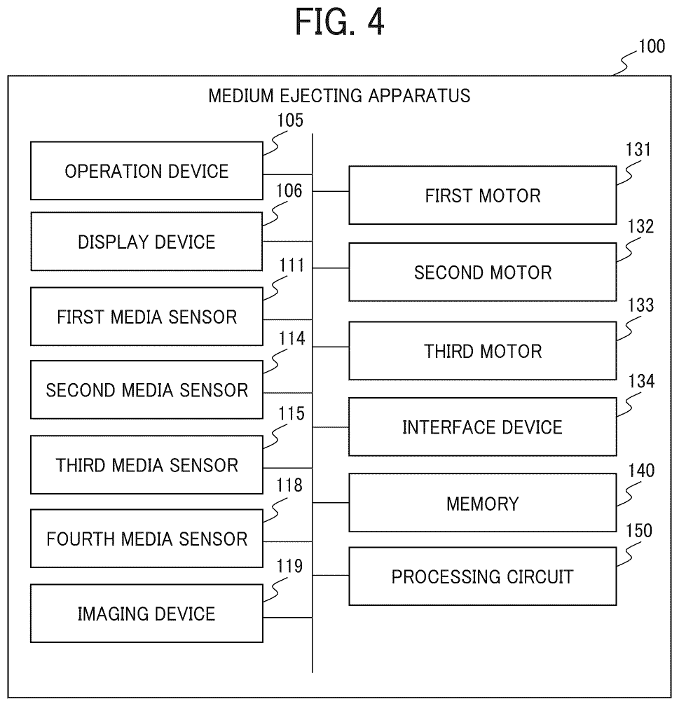

FIG. 4 is a block diagram illustrating a schematic configuration of the medium ejecting apparatus 100.

The medium ejecting apparatus 100 further includes an interface device 134, a memory 140, and a processing circuit 150 in addition to the configuration described above.

The interface device 134 includes an interface circuit compatible with a serial bus such as a universal serial bus (USB) and is electrically connected to an information processing apparatus (e.g., a personal computer or a mobile information processing terminal) to transmit and receive input images and various kinds of information to and from the information processing apparatus. The interface device 134 may be substituted by a communication device that includes an antenna to transmit and receive wireless signals and a wireless communication interface device to transmit and receive signals through a wireless communication line according to a predetermined communication protocol. The predetermined communication protocol is, for example, a wireless local area network (LAN) communication protocol. The communication unit may include a wired communication interface device to transmit and receive signals through a wired communication line according to a communication protocol such as a wired LAN communication protocol.

The memory 140 includes memories such as a random-access memory (RAM) and a read-only memory (ROM), a fixed disk device such as a hard disk, a portable memory such as a flexible disk or an optical disk, etc. The memory 140 stores data such as computer programs, databases, and tables used for various processes performed by the medium ejecting apparatus 100. The computer programs may be installed in the memory 140 from a computer-readable portable recording medium using, for example, a setup program. The portable recording medium is, for example, a compact disc read-only memory (CD-ROM) or a digital versatile disc read-only memory (DVD-ROM). The computer programs may be distributed from, for example, a server and installed in the memory 140.

The processing circuit 150 operates according to a program prestored in the memory 140. The processing circuit is, for example, a central processing unit (CPU). Alternatively, a digital signal processor (DSP), a large-scale integration (LSI), an application-specific integrated circuit (ASIC), or a field-programmable gate array (FPGA) may be used as the processing circuit 150.

The processing circuit 150 is connected to the operation device 105, the display device 106, the first media sensor 111, the second media sensor 114, the third media sensor 115, the fourth media sensor 118, the imaging device 119, the first motor 131, the second motor 132, the third motor 133, the interface device 134, and the memory 140, and controls these components. The processing circuit 150 controls the driving of the first motor 131, the second motor 132, and the third motor 133, the imaging of the imaging device 119, etc. to obtain line images from the imaging device 119, and transmits the line images to the information processing apparatus via the interface device 134. The processing circuit 150 detects the skew amount of the medium and controls the ejection roller 120 before the trailing end of the medium passes the ejection roller 120. Specifically, the processing circuit 150 controls the ejection roller 120 based on the detection result of the medium by the fourth media sensor 118 and the detected skew amount.

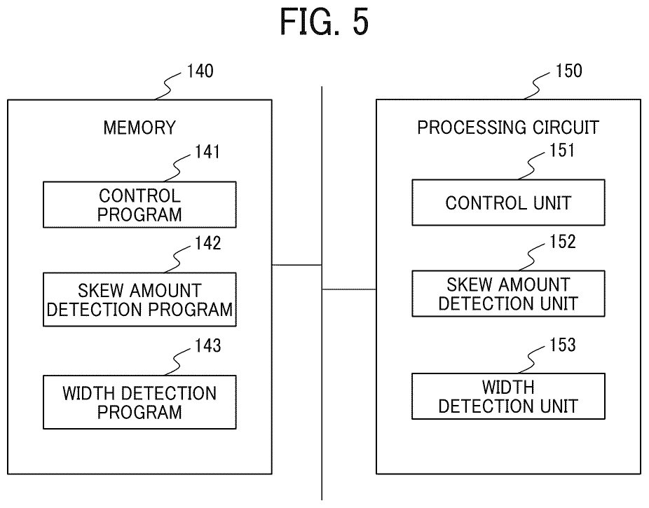

FIG. 5 is a schematic block diagram illustrating schematic configurations of the memory 140 and the processing circuit 150.

As illustrated in FIG. 5, the memory 140 stores programs such as a control program 141, a skew amount detection program 142, and a width detection program 143. These programs are functional modules implemented by software that operates on the processor. The processing circuit 150 reads the programs from the memory 140 and operates according to the read programs. Thus, the processing circuit 150 functions as a control unit 151, a skew amount detection unit 152, and a width detection unit 153.

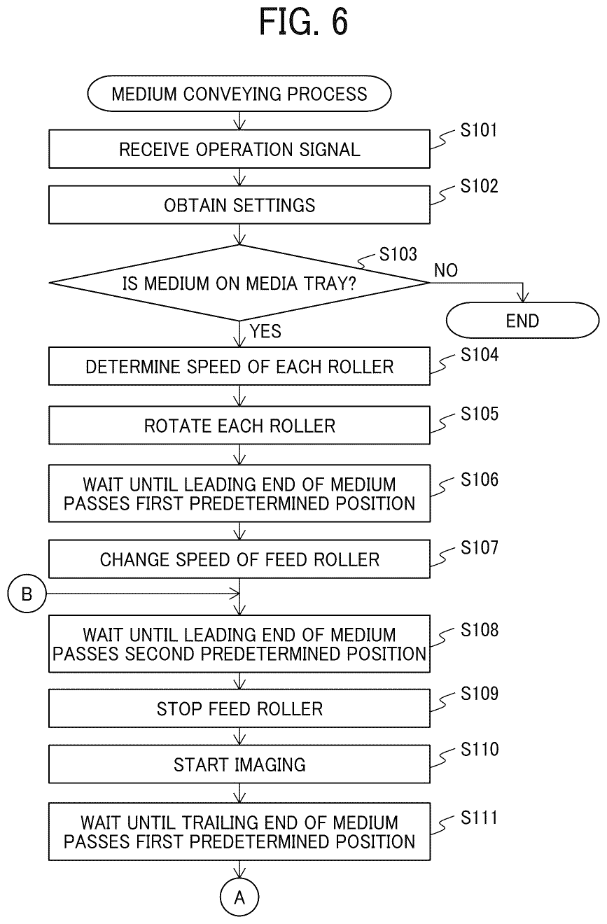

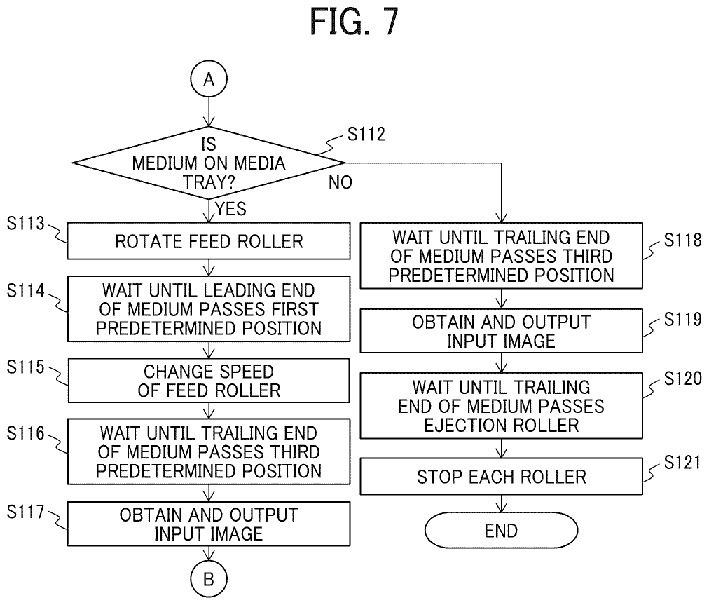

FIGS. 6 and 7 are flowcharts of a medium conveying process performed by the medium ejecting apparatus 100. FIG. 7 is a continuation of the flowchart of FIG. 6.

The medium conveying process performed by the medium ejecting apparatus 100 is described below with reference to the flowchart of FIGS. 6 and 7. The series of operations described below is executed, for example, by the processing circuit 150 in cooperation with the components of the medium ejecting apparatus 100 according to the programs prestored in the memory 140.

In step S101, the control unit 151 stands by until an operation signal instructing the reading of a medium is received from the operation device 105 or the interface device 134. The operation signal is output when a user inputs an instruction to read the medium using the operation device 105 or the information processing apparatus.

In step S102, the control unit 151 obtains the settings on the imaging processing, the image processing, or the medium conveying processing from the profile included in the operation signal. The profile is a collection of settings on the imaging processing, image processing, or medium conveying processing. The profile is set by a user according to, for example, the usage of an image to be generated or the type of medium to be imaged. The profile includes a setting of resolution in imaging by the imaging device 119 and an ejection mode. The ejection mode includes a speed change mode in which the speed of the ejection roller 120 is changed when the medium is ejected and a fixed speed mode in which the speed of the ejection roller 120 is not changed when the medium is ejected. The profile may be designated by the user before the input of the instruction to read a medium and stored in the memory 140 instead of being designated along with the instruction to read the medium. In such a case, the control unit 151 obtains the profile by reading the profile from the memory 140.

In step S103, the control unit 151 receives the first media signal from the first media sensor 111 and determines whether a medium is placed on the media tray 103 based on the first media signal. When no media are placed on the media tray 103, the control unit 151 ends the series of steps.

By contrast, when a medium is placed on the media tray 103 (Yes in step S103), the control unit 151 determines the speed of each roller based on the resolution obtained in step S102 (step S104). The speed of each roller determined by the control unit 151 is the speed at which the surface of each roller moves (i.e., the speed at which the medium is conveyed by the roller). The control unit 151 may determine the rotation speed of each roller as the speed of each roller. As the resolution increases, the imaging intervals by the imaging device 119 are reduced, and the speed of each roller is set to be lower. By contrast, as the resolution decreases, the imaging intervals by the imaging device 119 are increased, and the speed of each roller is set to be higher. The memory 140 preliminarily stores a table or an expression indicating the relationship between the resolution and the speed of each roller, and the control unit 151 determines the speed of each roller corresponding to each resolution with reference to the table or the expression stored in the memory 140.

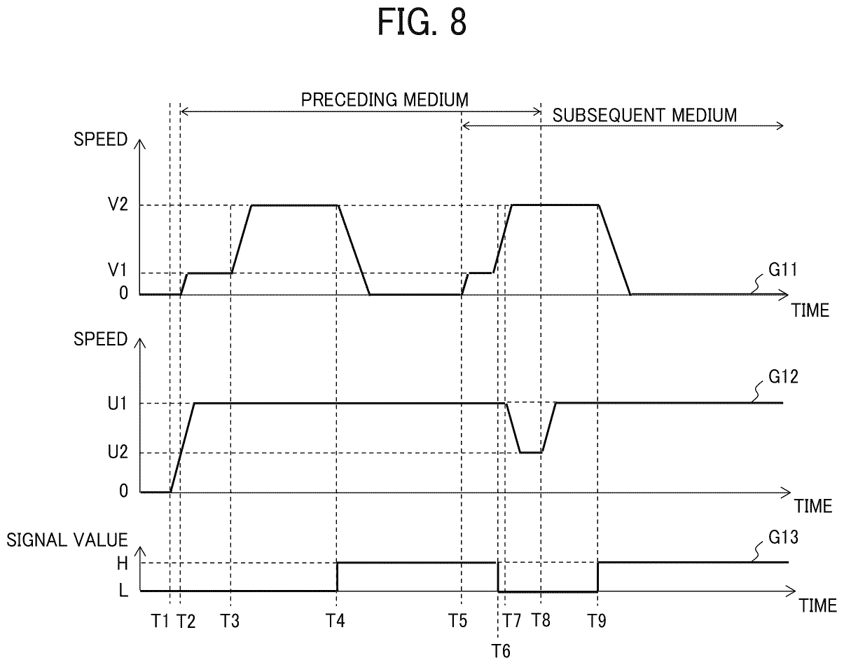

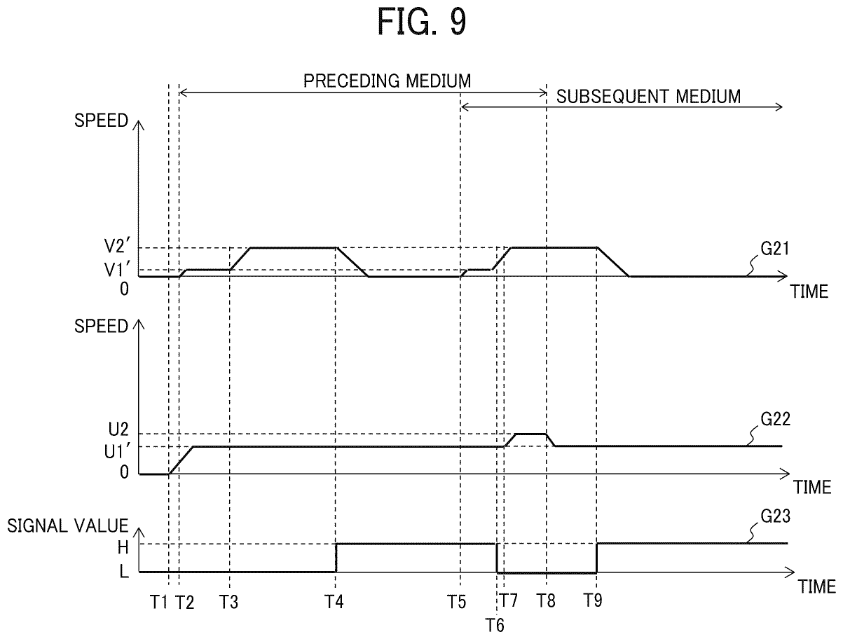

FIGS. 8 and 9 are graphs for explaining changes in the speed of the feed roller 112 and the conveyance roller 116.

FIG. 8 illustrates change in the speed of the rollers when the resolution is equal to or lower than a predetermined resolution threshold. FIG. 9 illustrates change in the speed of each roller when the resolution is higher than the resolution threshold. In FIGS. 8 and 9, graphs G11 and G21 indicate the speed change of the feed roller 112, and graphs G12 and G22 indicate the speed change of the conveyance roller 116. Since the speeds of the first facing roller 117, the ejection roller 120, and the second facing roller 121 change like the speed of the conveyance roller 116, the change in the speed of the conveyance roller 116 will be described below as a representative. The horizontal axes of the graphs G11, G11, G21, and G22 represent time, and the vertical axes represent the medium conveyance speed by the roller. Graphs G13 and G23 indicate changes in the signal value of the fourth media signal. The horizontal axes and the vertical axes of the graphs G13 and G23 indicate time and signal values, respectively. In the present embodiment, the signal value of the fourth media signal is low (L) when no medium is present at the position of the fourth media sensor 118 and high (H) when a medium is present at the position of the fourth media sensor 118.

In FIGS. 8 and 9, a time T1 indicates the time to start medium conveyance. The control unit 151 starts rotating the conveyance roller 116 at the time T1 and starts rotating the feed roller 112 at the time T2 after the elapse of a predetermined time from the time T1. As illustrated in FIG. 8, when the resolution is equal to or lower than the resolution threshold, the control unit 151 sets the speed of the conveyance roller 116 to an initial speed U1 and sets the speed of the feed roller 112 to an initial speed V1. The initial speed V1 is set to be lower (slower) than the initial speed U1. By contrast, as illustrated in FIG. 9, when the resolution is equal to or higher than the resolution threshold, the control unit 151 sets the speed of the conveyance roller 116 to an initial speed U1′ and sets the speed of the feed roller 112 to an initial speed V1′. The initial speed V1′ is set to be lower than the initial speed U1′. The initial speeds U1′ and V1′ are set to be lower than the initial speeds U1 and V1, respectively.

Subsequently, the control unit 151 drives the first motor 131, the second motor 132, and the third motor 133. Thus, the control unit 151 rotates the feed roller 112, the separation roller 113, the conveyance roller 116, the first facing roller 117, the ejection roller 120, and/or the second facing roller 121 to convey a medium in step S105.

The control unit 151 controls the first motor 131, the second motor 132, and the third motor 133 to rotate the rollers at the respective speeds determined in step S104. As illustrated in FIGS. 8 and 9, the rollers rotate at the determined speeds after the elapse of a predetermined through-up period from the start of driving of the respective motors at the time T1 or T2. After that, when the control unit 151 increases the speeds of the rollers, the rollers rotate at the set speeds after the elapse of a predetermined through-up period from the driving start of the motors similarly. Similarly, when the control unit 151 reduces the speeds of the rollers, the rollers rotate at the set speeds after the elapse of a predetermined through-down period from the driving start of the motors.

In step S106, the control unit 151 waits until the leading end of the conveyed medium passes a first predetermined position. For example, the first predetermined position is set at a position between the feed roller 112 and the conveyance roller 116 (or between the separation roller 113 and the first facing roller 117) in the medium ejecting direction A1. In particular, the first predetermined position is downstream from and near the nip between the feed roller 112 and the separation roller 113 in the medium ejecting direction A1. For example, the control unit 151 periodically obtains the second media signal and the third media signal from the second media sensor 114 and the third media sensor 115, respectively. The control unit 151 determines that the leading end of the medium passes the first predetermined position when the signal value of the second media signal or the third media signal changes from the value indicating the absence of a medium to the value indicating the presence of a medium. Alternatively, the control unit 151 may determine that the leading end of the medium passes the first predetermined position after the elapse of a first predetermined time from the start of the feeding of the medium. The first predetermined time is set to the time for the medium to move from the upstream end to the downstream end of the nip between the feed roller 112 and the separation roller 113 plus a margin.

In step S107, the control unit 151 changes the speed of the feed roller 112.

In FIGS. 8 and 9, a time T3 indicates the time when the leading end of the medium passes the first predetermined position. As illustrated in FIG. 8, when the resolution is equal to or lower than the resolution threshold, the control unit 151 changes the speed of the feed roller 112 to a final speed V2. The final speed V2 of the feed roller 112 is set to be higher than the initial speed V1 of the feed roller 112 and lower than the initial speed U1 of the conveyance roller 116. The final speed V2 of the feed roller 112 may be the same speed as the initial speed U1 of the conveyance roller 116. By contrast, as illustrated in FIG. 9, when the resolution is equal to or lower than the resolution threshold, the control unit 151 changes the speed of the feed roller 112 to a final speed V2′. The final speed V2′ of the feed roller 112 is set to be higher than the initial speed V1′ of the feed roller 112 and lower than the initial speed U1′ of the conveyance roller 116. The final speed V2′ of the feed roller 112 may be the same speed as the initial speed U1′ of the conveyance roller 116. The final speed V2′ is set to be lower than the final speed V2. In this way, the control unit 151 increases the speed of the feed roller 112 stepwise while decreasing the speed of the feed roller 112 during the medium separation period. Accordingly, the control unit 151 can reduce the processing time for medium conveyance while reducing the occurrence of multi-feed or jamming of the medium and step-out of the first motor 131. Thus, the control unit 151 can achieve both desirable feeding performance (reduction in the occurrence of abnormality) and desirable processing performance (reduction in conveyance time).

In step S108, the control unit 151 waits until the leading end of the conveyed medium passes a second predetermined position. For example, the second predetermined position is set at a position between the conveyance roller 116 and the first facing roller 117 and the imaging position of the imaging device 119 in the medium ejecting direction A1. For example, the second predetermined position is set at the position where the fourth media sensor 118 is located. The control unit 151 periodically obtains the fourth media signal from the fourth media sensor 118 and determines that the leading end of the medium passes the second predetermined position when the signal value of the fourth media signal changes from the value indicating the absence of a medium to the value indicating the presence of a medium.

In step S109, the control unit 151 controls the first motor 131 to stop the feed roller 112.

In FIGS. 8 and 9, a time T4 indicates the time when the leading end of the medium passes the position of the fourth media sensor 118. As illustrated in FIGS. 8 and 9, the control unit 151 stops the feed roller 112 (changes the speed to 0) after the leading end of the medium passes the position of the fourth media sensor 118. As a result, the medium is thereafter conveyed by the conveyance roller 116, and the feed roller 112 is rotated by the medium conveyed. The control unit 151 can prevent the medium from being pushed by the feed roller 112 and bent between the feed roller 112 and the conveyance roller 116, resulting in jamming, by stopping the feed roller 112.

In step S110, the control unit 151 controls the imaging device 119 to start imaging the medium. After that, the control unit 151 obtains the line images output from the imaging device 119 and stores the line images in the memory 140 each time the imaging device 119 outputs a predetermined number of line images. The predetermined number is set to one or more desired numbers.

In step S111, the control unit 151 waits until the trailing end of the conveyed medium passes the first predetermined position. The control unit 151 determines that the trailing end of the medium passes the first predetermined position when the signal value of the second media signal or the third media signal changes from the value indicating the presence of a medium to the value indicating the absence of a medium. Alternatively, the control unit 151 may determine that the trailing end of the medium passes the first predetermined position after the elapse of a second predetermined time from the start of feeding of the medium. The second predetermined time is set to the time from when the leading end of a largest medium supported by the medium ejecting apparatus 100 passes the upstream end of the nip between the feed roller 112 and the separation roller 113 to when the trailing end of the medium reaches the downstream end of the nip plus a margin.

In step S112, the control unit 151 determines whether a medium remains on the media tray 103 based on the first media signal received from the first media sensor 111.

When a medium remains on the media tray 103, the control unit 151 drives the first motor 131 to rotate the feed roller 112 to feed and convey the medium in S113. The control unit 151 controls the first motor 131 to rotate the feed roller 112 at the initial speed determined in step S104.

In FIGS. 8 and 9, a time T5 indicates the time when the trailing end of the medium passes the first predetermined position. As illustrated in FIG. 8, when the resolution is equal to or lower than the resolution threshold, the control unit 151 sets the speed of the feed roller 112 to the initial speed V1. By contrast, as illustrated in FIG. 9, when the resolution is higher than the resolution threshold, the control unit 151 sets the speed of the feed roller 112 to the initial speed V1′.

In step S114, the control unit 151 waits until the leading end of the subsequent medium passes the first predetermined position similar to the operation in step S106.

In step S115, the control unit 151 changes the speed of the feed roller 112 similar to the operation in step S107.

As illustrated in FIG. 8, when the resolution is equal to or lower than the resolution threshold, the control unit 151 changes the speed of the feed roller 112 to a final speed V2. By contrast, as illustrated in FIG. 9, when the resolution is equal to or lower than the resolution threshold, the control unit 151 changes the speed of the feed roller 112 to a final speed V2′.

In step S116, the control unit 151 waits until the trailing end of the preceding medium passes a third predetermined position. The third predetermined position is set to a position downstream by the overscan amount from the imaging position located on the downstream one of the first imaging position P1 of the first imaging device 119a and the second imaging position P2 of the second imaging device 119b in the medium ejecting direction A1. The initial value of the overscan amount is preliminarily set to an amount (for example, 16 mm) at which the entire medium is likely to be imaged even when the medium conveyed is skewed. The overscan amount can be changed in an ejection control process described later. The control unit 151 periodically obtains the fourth media signal from the fourth media sensor 118 and determines that the trailing end of the preceding medium passes the position of the fourth media sensor 118 when the signal value of the fourth media signal changes from the value indicating the presence of a medium to the value indicating the absence of a medium. The control unit 151 determines that the trailing end of the preceding medium passes the third predetermined position when a third predetermined time elapses from when the trailing end of the preceding medium passes the position of the fourth media sensor 118. The third predetermined time is set to the time for the medium to move from the position of the fourth media sensor 118 to the third predetermined position.

Subsequently, the control unit 151 controls the imaging device 119 to end imaging. In step S117, the control unit 151 generates an input image by combining the line images obtained from the imaging device 119 up to the current time and transmits (i.e., outputs) the input image to the information processing apparatus via the interface device 134. The medium ejecting apparatus 100 can image the entire medium even when the conveyed medium is skewed by controlling the imaging device 119 to continue imaging until the trailing end of the medium reaches the position downstream by the overscan amount from the imaging position.

The control unit 151 then returns the processing to step S108 and repeats the processing from step S108 for the subsequent medium. In this case, in step S108, the control unit 151 waits until the leading end of the subsequent medium passes the second predetermined position (at a time T9 in FIGS. 8 and 9). In step S109, the control unit 151 controls the first motor 131 to stop the feed roller 112.

By contrast, when no medium remains on the media tray 103 (No in step S112), the control unit 151 waits until the trailing end of the conveyed medium passes the third predetermined position in step S118 similar to the operation in step S116. In step S119, the control unit 151 transmits (i.e., outputs) the input image to the information processing apparatus via the interface device 134 similar to the operation in step S117.

In step S120, the control unit 151 waits until the trailing end of the conveyed medium passes the position of the ejection roller 120. The control unit 151 determines that the trailing end of the medium passes the position of the ejection roller 120 when a fourth predetermined time elapses from when the trailing end of the medium passes the position of the fourth media sensor 118. The fourth predetermined time is set to the time for the medium to move from the position of the fourth media sensor 118 to the downstream end of the nip between the ejection roller 120 and the second facing roller 121 plus a margin.

In step S121, the control unit 151 controls the second motor 132 and the third motor 133 to stop the separation roller 113, the conveyance roller 116, the first facing roller 117, the ejection roller 120, and/or the second facing roller 121 and ends the series of steps.

The operation in steps S106 to S107 and/or the operation in step S114 to step S115 may be omitted. In this case, the feed roller 112 may be set to the final speed V2 or V2′ at the start of rotation in step S105 and/or step S113.

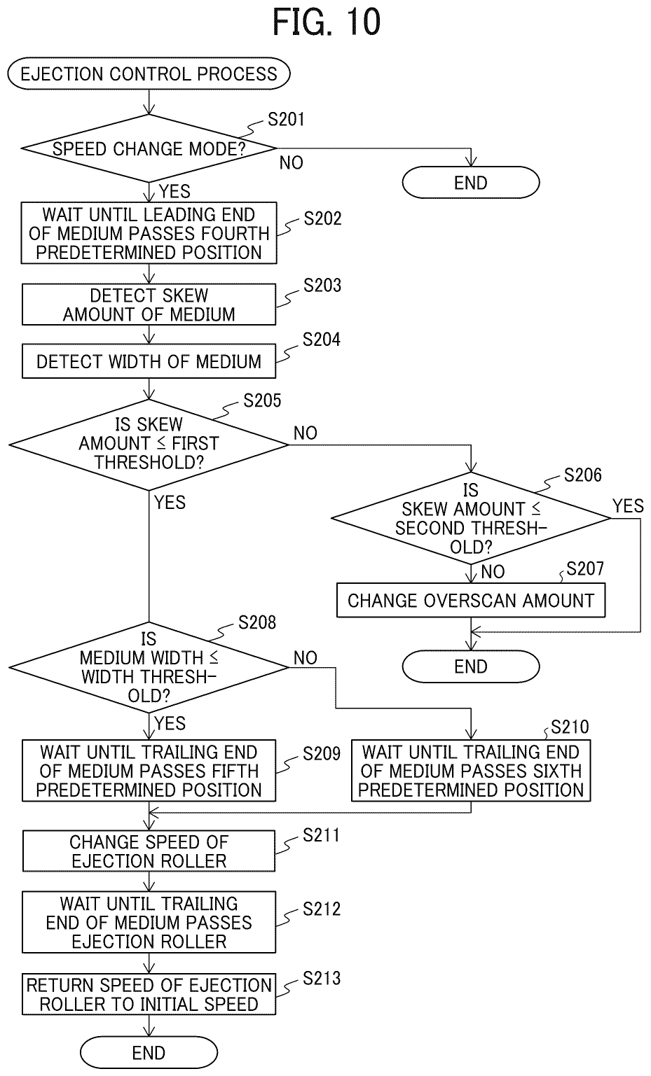

FIG. 10 is a flowchart of example operations in the ejection control process by the medium ejecting apparatus 100.

The example operations in the ejection control process performed by the medium ejecting apparatus 100 is described below with reference to the flowchart of FIG. 10. The series of operations described below is executed, for example, by the processing circuit 150 in cooperation with the components of the medium ejecting apparatus 100 according to the programs prestored in the memory 140. The ejection control process is executed in parallel to the medium conveying process every time a medium is conveyed.

In step S201, the control unit 151 determines whether the ejection mode obtained in step S102 of FIG. 6 is set to the speed change mode or the fixed speed mode. When the ejection mode is set to the fixed speed mode (No in step 201), the control unit 151 ends the series of steps without changing the speed of the ejection roller 120.

By contrast, when the ejection mode is set to the speed change mode (Yes in step S201), the control unit 151 waits until the leading end of the medium passes the fourth predetermined position (step S202). For example, the fourth predetermined position is set at a position downstream by a predetermined distance from the imaging position of the imaging device 119 in the medium ejecting direction A1. For example, the control unit 151 periodically obtains the fourth media signal from the fourth media sensor 118 and determines that the leading end of the medium passes the position of the fourth media sensor 118 when the signal value of the fourth media signal changes from the value indicating the absence of a medium to the value indicating the presence of a medium. The control unit 151 determines that the leading end of the medium passes the imaging position when a fifth predetermined time elapses from when the leading end of the medium passes the position of the fourth media sensor 118. The fifth predetermined time is set to the time for the medium to move from the position of the fourth media sensor 118 to the fourth predetermined position plus a margin. Alternatively, the control unit 151 may determine that the leading end of the medium passes the fourth predetermined position after the elapse of a sixth predetermined time from the start of feeding of the medium. The sixth predetermined time is set to the time for the medium to move from the upstream end of the nip between the feed roller 112 and the separation roller 113 to the fourth predetermined position plus a margin.

In step S203, the skew amount detection unit 152 detects the skew amount of the medium.

The skew amount detection unit 152 detects the skew amount of the medium based on, for example, the line image generated by the imaging device 119. The skew amount detection unit 152 generates a partial image by combining line images obtained from the imaging device 119 so far and detects the skew amount of the medium from the partial image. The skew amount detection unit 152 first calculates, for each vertical line extending in the vertical direction (sub-scanning direction) within the partial image, the absolute value of the difference in pixel value between two vertically adjacent pixels from the leading end of the partial image. This difference in absolute value may be referred to as the “adjacent difference value” in the following description. The skew amount detection unit 152 detects pixels between which the adjacent difference value exceeds a pixel value threshold in each vertical line as edge pixels. The pixel value is, for example, a brightness value or a color value such as an R value, a G value, or a B value. The pixel value threshold is set to, for example, a difference in brightness value (e.g., 20) at which a person visually perceives a difference in brightness on an image. The skew amount detection unit 152 detects an edge pixel at the leading end in each vertical line as a leading edge pixel.

Alternatively, the skew amount detection unit 152 may calculate the absolute value of the difference in pixel value between two pixels that are apart from each other by a predetermined distance in the vertical direction as the adjacent difference value. The skew amount detection unit 152 may detect the edge pixel by comparing the pixel value of each pixel with a threshold. For example, when the pixel value of a particular pixel is less than the threshold and the pixel value of a pixel adjacent to or apart by the predetermined distance from the particular pixel in the vertical direction is equal to or greater than the threshold, the skew amount detection unit 152 detects the particular pixel as the edge pixel.

Subsequently, the skew amount detection unit 152 detects a straight line (line segment) as the leading side of the medium based on the leading edge pixels using the least squares method. Alternatively, the skew amount detection unit 152 may detect the straight line using the Hough transform. When multiple straight lines are detected based on the leading edge pixels, the skew amount detection unit 152 may detect a straight line having the largest length in the horizontal direction (main scanning direction) as the leading side of the medium. The skew amount detection unit 152 detects an angle θ formed by the detected straight line (the leading side of the medium) and the horizontal direction as the skew amount of the medium. The skew amount detection unit 152 can detect the skew amount of the medium with high accuracy by using the line images generated by the imaging device 119.

The skew amount detection unit 152 may detect the skew amount of the medium based on the line images generated by one of the first and second imaging devices 119a and 119b whose imaging position is located upstream from the imaging position of the other imaging device. This enables the skew amount detection unit 152 to detect the skew amount of the medium earlier.

The skew amount detection unit 152 may detect the skew amount of the medium based on the detection results of the medium by the second and third media sensors 114 and 115. In this case, the skew amount detection unit 152 detects the time when the leading end of the medium passes the position of the second media sensor 114 and the time when the leading end of the medium passes the position of the third media sensor 115 similar to the operation in step S104 in FIG. 6, and calculates the time difference therebetween. The skew amount detection unit 152 multiplies the calculated time difference with the conveyance speed of the medium and detects the product as the skew amount of the medium. The product represents the distance by which the leading end of the medium moves from the position of one of the second media sensor 114 and the third media sensor 115 to the position of the other media sensor. Alternatively, the skew amount detection unit 152 may divide the product by the width W (see FIG. 3) between the second and third media sensors 114 and 115 in the width direction A2 and detect the result (i.e., the tangent of the leading end of the medium to the width direction A2) as the skew amount of the medium. Alternatively, the skew amount detection unit 152 may detect the arctangent of the result of the division (i.e., the angle of the leading end of the medium relative to the width direction A2) as the skew amount of the medium. The skew amount detection unit 152 can detect the skew amount of the medium with high accuracy also when the detection results of the medium by the second and third media sensors 114 and 115 are used.

The skew amount detection unit 152 may detect the skew amount of the medium based on the trailing end of the medium. In this case, in step S202, the control unit 151 waits until the trailing end of the medium passes the third predetermined position. The skew amount detection unit 152 detects an edge pixel at the trailing end in each vertical line as a trailing edge pixel. The skew amount detection unit 152 detects a straight line based on the trailing edge pixels as the lower side of the medium using the least squares method or Hough transformation, and detects the angle formed by the detected straight line and the horizontal direction as the skew amount of the medium. Alternatively, the skew amount detection unit 152 may detect the skew amount of the medium based on the difference between the time when the trailing end of the medium passes the position of the second media sensor 114 and the time when the trailing end of the medium passes the position of the third media sensor 115. Accordingly, when the medium is skewed, the medium ejecting apparatus 100 can control the ejection of the medium based on the state of the medium immediately before the ejection and can more appropriately eject the medium. By contrast, detecting the skew amount of the medium based on the leading end of the medium allows the medium ejecting apparatus 100 to identify the skew amount of the medium earlier and have sufficient time to control the ejection of the medium.

The skew amount detection unit 152 may detect the skew amount of the medium based on the left end and/or the right end of the medium. In this case, the skew amount detection unit 152 calculates, for each horizontal line extending in the horizontal direction (main scanning direction) in the partial image, an adjacent difference value between each two pixels in the horizontal direction line from the left end, and detects pixels between which the adjacent difference value exceeds a pixel value threshold as an edge pixel. The width detection unit 153 detects the leftmost edge pixel and the rightmost edge pixel in each horizontal line as the left end and the right end of the medium, respectively. Alternatively, the skew amount detection unit 152 may calculate the absolute value of the difference in pixel value between two pixels that are apart from each other by a predetermined distance in the horizontal direction as the adjacent difference value. The skew amount detection unit 152 may detect the edge pixel by comparing the pixel value of each pixel with a threshold. For example, when the pixel value of a particular pixel is less than the threshold and the pixel value of a pixel adjacent to or apart by the predetermined distance from the particular pixel in the horizontal direction is equal to or greater than the threshold, the skew amount detection unit 152 detects the particular pixel as the edge pixel. The skew amount detection unit 152 detects a straight line based on the left edge pixels as the left side of the medium using the least squares method or Hough transformation, and detects the angle formed by the detected straight line and the vertical direction as the skew amount of the medium. In addition to or in alternative to the left side, the skew amount detection unit 152 may detect a straight line based on the right edge pixels as the right side of the medium similarly.

In step S204, the width detection unit 153 detects the width of the medium.

For example, the width detection unit 153 detects the width of the medium from the partial image. The width detection unit 153 detects the left end and the right end of the medium in a predetermined horizontal line and detects the distance therebetween as the width of the medium.

The width detection unit 153 may detect the width of the medium based on the line images generated by one of the first and second imaging devices 119a and 119b whose imaging position is located upstream from the imaging position of the other imaging device. This enables the width detection unit 153 to detect the width of the medium earlier.

The width detection unit 153 may detect the width of the medium based on the detection result of the medium by the media sensor. In this case, the medium ejecting apparatus 100 includes one or more media sensors located at the same position as each of the second media sensor 114 and the third media sensor 115 in the medium ejecting direction A1 and spaced apart from each of the second media sensor 114 and the third media sensor 115 in the width direction A2. The width detection unit 153 detects the distance between the two media sensors located farthest from the center in the width direction A2 among the media sensors detecting the medium or the passage of the medium as the width of the medium.

The profile obtained in step S102 of FIG. 6 may include the size of the medium to be conveyed, and the width detection unit 153 may identify the width of the medium from the medium size.

When the skew amount and the width of the medium are detected without using the partial image, the third predetermined position may be upstream from the imaging position. This enables the medium ejecting apparatus 100 to identify the skew amount and the width of the medium earlier and have sufficient time to control the ejection of the medium.

In step S205, the control unit 151 determines whether the skew amount of the medium detected by the skew amount detection unit 152 is equal to or less than a first threshold. The first threshold is an example of a skew amount threshold. For example, the first threshold is set to the value (e.g., the value equivalent to 3 degrees) obtained by subtracting a margin from the maximum skew amount of the medium with which the entire medium can be imaged when the medium is overscanned by the initial value of the overscan amount.

When the skew amount is greater than the first threshold (No in step S205), the control unit 151 determines whether the skew amount is equal to or less than a second threshold greater than the first threshold (step S206). For example, the second threshold is set to the minimum skew amount (e.g., the value equivalent to 12 degrees) of the medium with which a part of the medium is not imaged even though the medium is overscanned by the initial value of the overscan amount. When the skew amount of the medium is equal to or less than the second threshold, the control unit 151 ends the series of steps without changing the speed of the ejection roller 120.

By contrast, when the skew amount of the medium is greater than the second threshold (No in step S206), the control unit 151 increases the overscan amount by the imaging device 119 (step S207). The change value of the overscan amount is preliminarily set such that the entire medium is imaged even when the skew amount of the medium is greater than the second threshold. The change value of the overscan amount may be set according to the skew amount of the medium. In this case, the change value of the overscan amount is set to a larger value as the skew amount of the medium increases. Thus, the control unit 151 increases the imaging time of the imaging device 119 in steps S116 to S117 of FIG. 7 to make sure that the entire medium is imaged when the conveyed medium is skewed. Then, the control unit 151 ends the series of steps without changing the speed of the ejection roller 120.

By contrast, when the skew amount is equal to or less than the first threshold (Yes in step S205), the control unit 151 determines whether the width of the sheet detected by the width detection unit 153 is equal to or less than the width threshold (step S208). The width threshold is set to a value (for example, 100 mm) between the width of a standard medium such as A4 plain paper copier (PPC) and the width of a small medium such as a business card or a receipt.

When the width of the medium is equal to or less than the width threshold (Yes in step S208), the control unit 151 waits until the trailing end of the medium passes a fifth predetermined position (step S209). The fifth predetermined position is set at a position downstream from the imaging position of the imaging device 119 and upstream from the ejection roller 120 in the medium ejecting direction A1. In particular, the fifth predetermined position is set to a position downstream by a first distance from the downstream one of the first imaging position P1 of the first imaging device 119a and the second imaging position P2 of the second imaging device 119b in the medium ejecting direction A1. The first distance is smaller than the initial value of the overscan amount. For example, when the initial value of the overscan amount is 16 mm, the first distance is 5 mm. The control unit 151 determines that the trailing end of the medium passes the fifth predetermined position when a seventh predetermined time elapses from when the trailing end of the medium passes the position of the fourth media sensor 118. The seventh predetermined time is set to the time for the medium to move from the position of the fourth media sensor 118 to the fifth predetermined position.

By contrast, when the width of the medium is greater than the width threshold (No in step S208), the control unit 151 waits until the trailing end of the medium passes the sixth predetermined position (step S210). The sixth predetermined position is set to a position downstream from the imaging position of the imaging device 119 and upstream from the ejection roller 120 in the medium ejecting direction A1. In particular, the sixth predetermined position is set to a position downstream by a second distance from the downstream one of the first imaging position P1 of the first imaging device 119a and the second imaging position P2 of the second imaging device 119b in the medium ejecting direction A1. The second distance is greater than the first distance and smaller than the initial value of the overscan amount. For example, when the initial value of the overscan amount is 16 mm and the first distance is 5 mm, the second distance is 11 mm. The control unit 151 determines that the trailing end of the medium passes the fifth predetermined position when an eighth predetermined time elapses from when the trailing end of the medium passes the position of the fourth media sensor 118. The eighth predetermined time is set to the time for the medium to move from the position of the fourth media sensor 118 to the sixth predetermined position.

In step S211, the control unit 151 changes the speed of the ejection roller 120. The control unit 151 reduces the speed of the ejection roller 120 when the resolution in the imaging by the imaging device 119 is equal to or lower than the resolution threshold and increases the speed of the ejection roller 120 when the resolution in the imaging by the imaging device 119 is higher than the resolution threshold. The speed of the ejection roller 120 after the change is preliminarily set to such a speed that the ejected medium is not forced to fall from the ejection tray 104, not scattered on the ejection tray 104, and does not remain near the ejection port.

In FIGS. 8 and 9, a time T6 indicates the time when the trailing end of the medium passes the position of the fourth media sensor 118, and a time T7 indicates the time when the trailing end of the medium passes the fifth predetermined position. In the example illustrated in FIGS. 8 and 9, the control unit 151 changes the speed of the conveyance roller 116 (the ejection roller 120) to an ejection speed U2 at the time T7 at which the trailing end of the medium passes the fifth predetermined position. The ejection speed U2 of the conveyance roller 116 (the ejection roller 120) is set to a speed lower than the initial speed U1 of the conveyance roller 116 when the resolution is equal to or lower than the resolution threshold and higher than the initial speed U1′ of the conveyance roller 116 when the resolution is higher than the resolution threshold.

That is, when the resolution is equal to or lower than the resolution threshold, the ejection speed U2 of the ejection roller 120 is set to be lower than the initial speed U1. Accordingly, the medium ejecting apparatus 100 can prevent the medium from falling from the ejection tray 104 or scattering on the ejection tray 104 by ejecting the medium at low speed while shortening medium conveyance time by conveying the medium at high speed till the medium is ejected. By contrast, when the resolution is higher than the resolution threshold, the ejection speed U2 of the ejection roller 120 is set to be higher than the initial speed U1′. Accordingly, the medium ejecting apparatus 100 can prevent the occurrence of the jamming of the medium due to a medium remaining near the ejection port by ejecting the medium at high speed while reliably imaging the medium by conveying the medium at low speed during the imaging of the medium.

In this way, the control unit 151 controls the ejection roller 120 before the trailing end of the medium passes the ejection roller 120 based on the detection result by the fourth media sensor 118 and the skew amount of the medium. Thus, the medium ejecting apparatus 100 changes the speed of the ejection roller 120 when it is determined that the imaging of the entire medium is completed based on the position of the medium and the skew amount of the medium.

In particular, the control unit 151 changes the speed of the ejection roller 120 on the condition that the skew amount of the medium is equal to or less than the skew amount threshold. This enables the medium ejecting apparatus 100 to change the speed of the ejection roller 120 when the skew amount of the medium is small and the possibility that the imaging of the entire medium is completed is high. Therefore, the medium ejecting apparatus 100 can prevent the distortion (stretching or shrinking) of the generated input image due to a change in the conveyance speed of the medium during the imaging of the medium by the imaging device 119.

As described above, the fifth predetermined position or the sixth predetermined position used as the reference for the timing of changing the speed of the ejection roller 120 is upstream from the ejection roller 120. Accordingly, the control unit 151 changes the speed of the ejection roller 120 before the trailing end of the medium passes the ejection roller 120. This enables the medium ejecting apparatus 100 to reliably change the ejection speed of the medium by the ejection roller 120.

The control unit 151 changes the speed of the ejection roller 120 based on the width of the medium. Accordingly, when the medium is small and the overscan amount is small, the medium ejecting apparatus 100 can change the ejection roller 120 earlier to more reliably prevent the medium from falling from the ejection tray 104 or scattering on the ejection tray 104. By contrast, the medium ejecting apparatus 100 can image the entire medium more reliably by increasing the overscan amount for a standard size medium.

Note that the control unit 151 may not change the speed of the ejection roller 120 when the resolution in the imaging by the imaging device 119 is higher than the resolution threshold. In this case, the medium ejecting apparatus 100 can reliably image the medium by conveying the medium at low speed during the imaging and can prevent the medium from falling from the ejection tray 104 or scattering on the ejection tray 104 by ejecting the medium at low speed.

In step S212, the control unit 151 waits until the trailing end of the ejected medium passes the position of the ejection roller 120 similar to the operation in step S120 in FIG. 6.

In step S213, the control unit 151 returns the speed of the ejection roller 120 to the initial speed U1 or U1′ and ends the series of steps.

In FIGS. 8 and 9, a time T8 indicates the time when the trailing end of the medium passes the position of the ejection roller 120. As illustrated in FIGS. 8 and 9, the control unit 151 returns the speed of the conveyance roller 116 (the ejection roller 120) to the initial speed U1 or U1′ at the time T8 when the trailing end of the medium passes the position of the ejection roller 120.

The conveyance roller 116 and the ejection roller 120 are driven by the third motor 133. Thus, until the speed of the ejection roller 120 returns to the initial speed, the speed of the conveyance roller 116 does not return to the initial speed, and the conveyance roller 116 should not convey the subsequent medium. Accordingly, the initial speed, the final speed, the ejection speed, and/or the timing of speed change of each roller are set in advance such that the speed of the conveyance roller 116 returns to the initial speed before the leading end of the subsequent medium passes the position of the conveyance roller 116 (the time T9 in FIGS. 8 and 9). With such speed setting, the subsequent medium is fed by the feed roller 112 and the separation roller 113 but does not reach the position of the conveyance roller 116 while the speed of the ejection roller 120 is changed. Therefore, the subsequent medium is preferably fed even if the speed of the conveyance roller 116 driven by the third motor 133 common to the ejection roller 120 changes together with the ejection roller 120.

In this way, the control unit 151 controls the ejection roller 120 to return the speed of the ejection roller 120 before the leading end of the subsequent medium reaches the conveyance roller 116. The medium ejecting apparatus 100 returns the speed of the ejection roller 120 before the subsequent medium reaches the conveyance roller 116 driven by the third motor 133 common to the ejection roller 120. Accordingly, the conveyance roller 116 can stably convey the subsequent medium at the same speed as or a speed higher than the speed of the feed roller 112, and the medium ejecting apparatus 100 can prevent the jamming of the medium and creases in the medium. The conveyance roller 116 can convey the medium at a constant speed at the imaging position, and the medium ejecting apparatus 100 can prevent the distortion of the input image.

The control unit 151 may change the speed of the ejection roller 120, the start timing of speed change, and/or the duration of speed change according to the skew amount of the medium. For example, as the skew amount of the medium is smaller, the control unit 151 advances the start timing of speed change, reduces the speed of the ejection roller 120, and/or shortens the duration of speed change. Accordingly, the medium ejecting apparatus 100 can prevent the medium from falling from the ejection tray 104 or scattering on the ejection tray 104 as the skew amount of the medium is smaller. The control unit 151 may delay the start timing of speed change, increase the speed of the ejection roller 120, or extend the duration of speed change as the skew amount of the medium is smaller.

The control unit 151 may change the speed of the ejection roller 120, the start timing of speed change, and/or the duration of speed change according to the width of the medium. For example, as the width of the medium is smaller, the control unit 151 advances the start timing of speed change, reduces the speed of the ejection roller 120, and/or shortens the duration of speed change. Accordingly, the medium ejecting apparatus 100 can prevent the medium from falling from the ejection tray 104 or scattering on the ejection tray 104 as the width of the medium is smaller. The control unit 151 may delay the start timing of speed change, increase the speed of the ejection roller 120, or extend the duration of speed change as the width of the medium is smaller.

The operation in step S205 and/or the operation in steps S206 to S207 may be omitted. The operations in steps S204 and S208 may be omitted. In this case, the operation in either step S209 or step S210 is executed unconditionally.

In the flowcharts of FIGS. 6 and 7, when the trailing end of the preceding medium passes the first predetermined position (step S111), the feed roller 112 is rotated again (step S113) to feed the subsequent medium. However, the timing of feeding is not limited thereto.

For example, the control unit 151 may feed the subsequent medium by rotating the feed roller 112 again when the speed of the ejection roller 120 is returned to the initial speed. The control unit 151 determines that the speed of the ejection roller 120 returns to the initial speed when the through-up period elapses from when the control unit 151 controls the third motor 133 to return the speed of the ejection roller 120 to the initial speed.

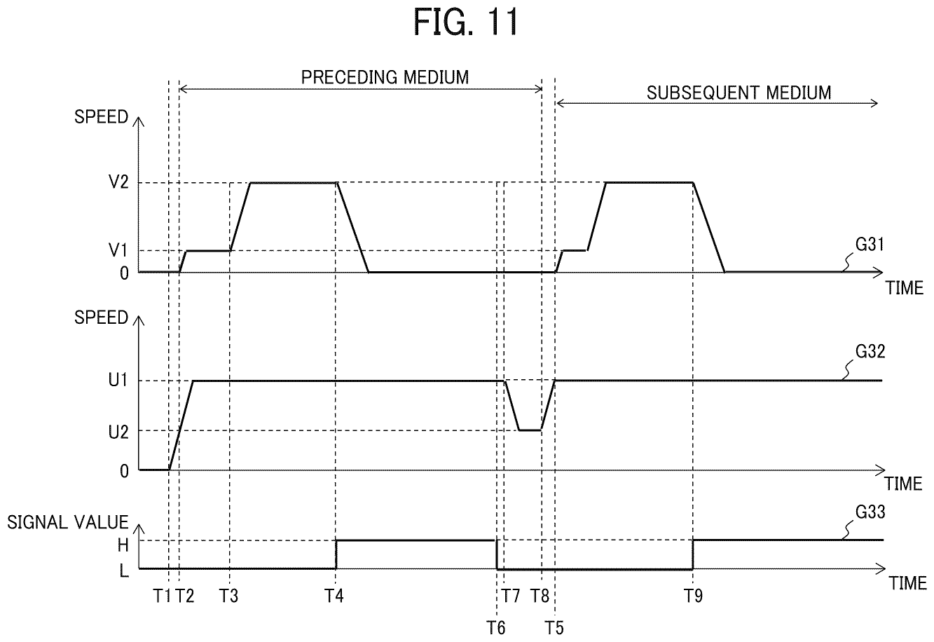

FIG. 11 is a graph for explaining a change in the speed of the feed roller 112 and the conveyance roller 116 in a case where the feed roller 112 is rotated again when the speed of the ejection roller 120 is returned to the initial speed.

FIG. 11 illustrates the change in the speed of the rollers when the resolution is equal to or lower than the resolution threshold. In FIG. 11, a graph G31 indicates the speed change of the feed roller 112, and a graph G32 indicates the speed change of the conveyance roller 116. The horizontal axes of the graphs G31 and G32 represent time, and the vertical axes represent the conveyance speeds of the medium by the feed roller 112 and the conveyance roller 116. A graph G33 indicates a change in the signal value of the fourth media signal. The horizontal axis of the graph G33 indicates time, and the vertical axis thereof indicates the signal value.

In FIG. 11, at the time T5 when the feed roller 112 is rotated again at the initial speed V1, the speed of the ejection roller 120 returns to the initial speed U1. When the speed of the ejection roller 120 returns to the initial speed U1, the control unit 151 rotates again the feed roller 112 at the initial speed V1 to feed the subsequent medium. Accordingly, the medium ejecting apparatus 100 can reliably prevent the subsequent medium from colliding with the preceding medium and can prevent the jamming of the medium and damage to the medium.

The control unit 151 may change the speed of the feed roller 112 to the initial speed V1 or V1′ before the trailing end of the preceding medium passes the ejection roller 120, and may change the speed of the feed roller 112 to the final speed V2 or V2′ when the speed of the ejection roller 120 returns to the initial speed.

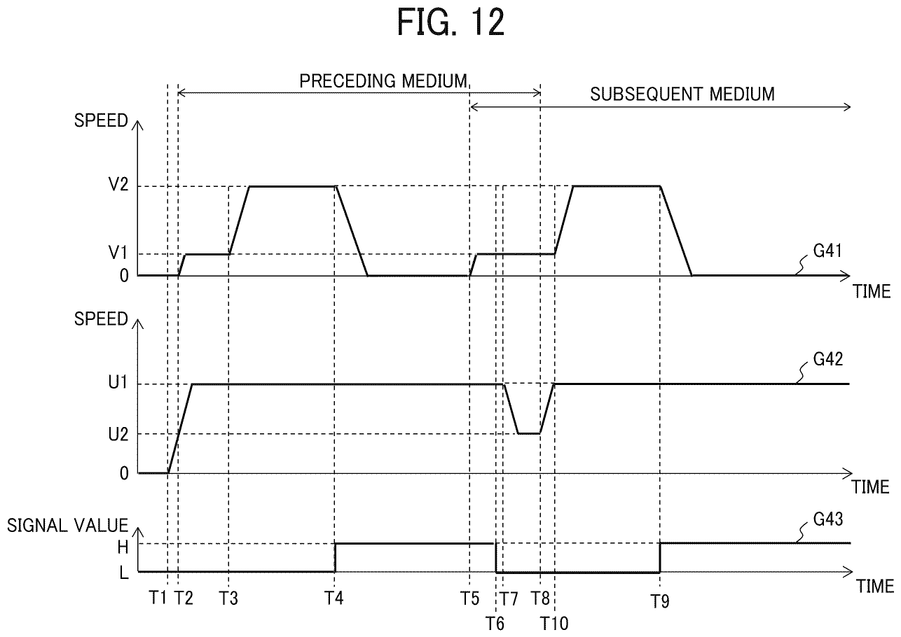

FIG. 12 is a graph for explaining a change in the speed of the feed roller 112 and the conveyance roller 116 in a case where the speed of the feed roller 112 is changed to the final speed when the speed of the ejection roller 120 is returned to the initial speed.

FIG. 12 illustrates the change in the speed of the rollers when the resolution is equal to or lower than the resolution threshold. In FIG. 12, a graph G41 indicates the speed change of the feed roller 112, and a graph G42 indicates the speed change of the conveyance roller 116. The horizontal axes of the graphs G41 and G42 represent time, and the vertical axes represent the conveyance speeds of the medium by the rollers. A graph G43 indicates a change in the signal value of the fourth media signal. The horizontal axis of the graph G43 indicates time, and the vertical axis thereof indicates the signal value.

In FIG. 12, at a time T10 when the feed roller 112 is rotated at the final speed V2, the speed of the ejection roller 120 returns to the initial speed. The control unit 151 sets the speed of the feed roller 112 to the final speed V2 to increase the feeding speed when the speed of the ejection roller 120 returns to the initial speed. Accordingly, the medium ejecting apparatus 100 can increase the productivity of input images by reducing the conveyance time of media while preventing the collision of the subsequent medium with the preceding medium.

By contrast, in FIGS. 8 and 9, the medium ejecting apparatus 100 sets the speed of the feed roller 112 to the final speed V2 before the trailing end of the preceding medium passes the position of the ejection roller 120. Accordingly, the medium ejecting apparatus 100 can increase the productivity of input images by reducing the conveyance time of media.

As described above in detail, the medium ejecting apparatus 100 controls the ejection roller 120 based on the detection result by the fourth media sensor 118 located between the conveyance roller 116 and the imaging device 119 and the skew amount of the medium. Thus, the medium ejecting apparatus 100 controls the ejection roller 120 when it is determined that the imaging of the entire medium is completed based on the position of the medium and the skew amount of the medium. Thus, the medium ejecting apparatus 100 can properly eject a medium while properly imaging the medium.

The medium ejecting apparatus 100 conveys the medium at a constant speed from the start of reading the medium to the completion of the reading to maintain a constant relationship between the reading timing of the medium by the imaging device 119 and the speed of the medium. As a result, the distortion (stretching or shrinking) of the input image can be prevented. In addition, the medium ejecting apparatus 100 can enhance the alignment of the ejected media by changing the speed of the media from the completion of the reading to the completion of the ejection. In addition, the medium ejecting apparatus 100 can appropriately convey the subsequent medium by returning the speed of the medium before starting the reading of the subsequent medium.

Since a motor rotates at an instructed speed after the elapse of a predetermined through-up period or through-down period from when the speed change is instructed, it takes time to change the speed of the roller to the target speed. Typically, a distance of about 5 mm to 10 mm is required to change the speed suitable for imaging by the imaging device to the speed suitable for ejecting media in an aligned manner. By contrast, in a medium ejecting apparatus having a straight medium conveying path, the distance between the imaging device and the ejection roller is small and the conveyance roller and the ejection roller are driven by a common motor to reduce the size, weight, and cost of the apparatus. Accordingly, when the medium conveyed is skewed, it is highly possible that the time from the completion of the imaging of the entire medium to the change of the speed of the ejection roller and the time from the completion of the ejection of the medium to the start of the conveyance of the subsequent medium are insufficient. The medium ejecting apparatus 100 changes the speeds of the ejection roller 120 and the conveyance roller 116 on condition that the skew amount of the medium is equal to or less than the skew amount threshold. That is, when the skew amount of the medium is equal to or less than the skew amount threshold, the medium ejecting apparatus 100 changes the speeds of the ejection roller 120 and the conveyance roller 116 assuming that the trailing end of the medium has passed the imaging position even during overscan. Accordingly, the medium ejecting apparatus 100 can enhance the alignment of the ejected media while preventing increases in the size, weight, and cost of the apparatus.

The medium ejecting apparatus 100 controls the ejection roller 120 using the detection result of the medium by the fourth media sensor 118 used to determine the imaging timing by the imaging device 119. Since a special sensor is not used to control the ejection roller 120, the medium ejecting apparatus 100 can control the ejection roller 120 while preventing increases in the size, weight, and cost of the apparatus.

The medium ejecting apparatus 100 may control the ejection roller 120 based on the extreme trailing end of the medium detected from the image generated by the imaging device 119 instead of the skew amount of the medium. The extreme trailing end is, for example, the trailing end of a tab projecting beyond the trailing end of the medium. In this case, the control unit 151 detects the left end and the right end of the medium from the line images obtained from the imaging device 119 as described in step S203 in FIG. 10. When the left end and the right end are detected in the line images, the control unit 151 determines that the trailing end of the medium has not yet passed the imaging position. By contrast, when the left end and the right end are no longer detected in the line image, the control unit 151 determines that the extreme trailing end of the medium has passed the imaging position.

The medium ejecting apparatus 100 preliminarily stores a roller region in the memory 140. The roller region is a region in the line image corresponding to a region where the imaging device 119 and the ejection roller 120 overlap when viewed from the medium ejecting direction A1 (a region where the imaging device 119 and the ejection roller 120 overlap in the width direction A2). The control unit 151 determines that the trailing end of the medium passes the ejection roller 120 when a ninth predetermined time elapses from when the roller region is no longer included in the region between the left end and the right end detected in the line image. The ninth predetermined time is set to the time for the medium to move from the imaging position of the imaging device 119 to the downstream end of the nip between the ejection roller 120 and the second facing roller 121.

The control unit 151 changes the speed of the ejection roller 120 when the extreme trailing end of the medium passes the imaging position before the trailing end of the medium passes the ejection roller 120. By contrast, the control unit 151 does not change the speed of the ejection roller 120 when the extreme trailing end of the medium does not pass the imaging position before the trailing end of the medium passes the ejection roller 120. Thus, even when a tab or the like is located at the trailing end of the medium and the trailing end of the medium is not linear, the medium ejecting apparatus 100 can properly perform the imaging process of the medium and properly eject the medium.

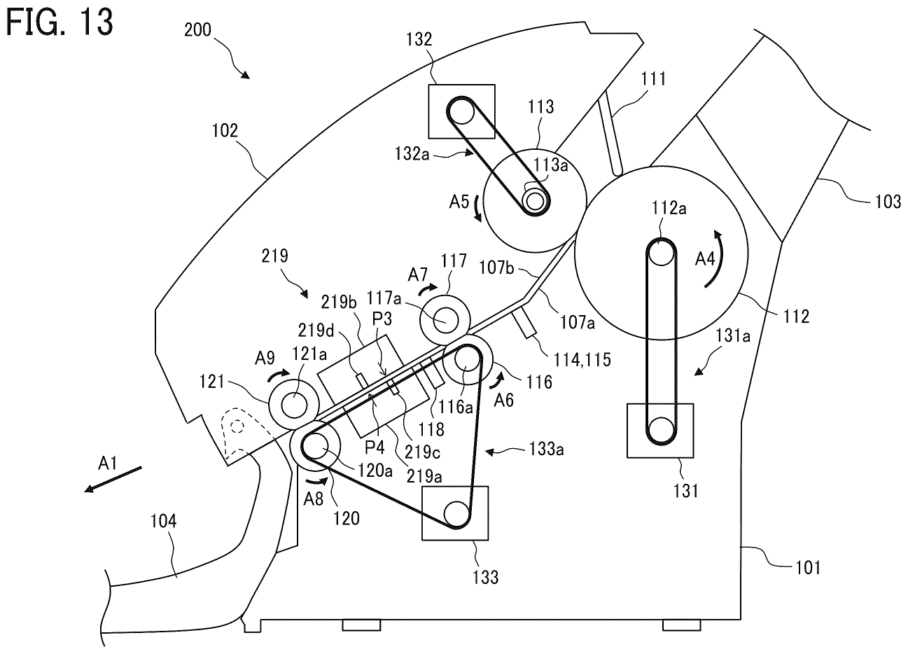

FIG. 13 is a diagram illustrating a conveying path inside a medium ejecting apparatus 200 according to another embodiment.

The medium ejecting apparatus 200 includes the elements included in the medium ejecting apparatus 100.

However, the medium ejecting apparatus 200 includes the image forming device 219 instead of the imaging device 119. In the medium ejecting apparatus 200, the image forming device 219 is located at a position corresponding to the position of the imaging device 119 in the medium ejecting apparatus 100.

The image forming device 219 is an example of the processing device and performs predetermined processing relative to the medium conveyed by the conveyance roller 116. The image forming device 219 forms an image on the medium conveyed by the conveyance roller 116 as the predetermined processing. The image forming device 219 includes a first image forming device 219a and a second image forming device 219b facing each other across the medium conveying path.

The first image forming device 219a prints predetermined information on the front side of the conveyed medium under the control of the processing circuit 150. The predetermined information is information such as characters and numerals designated by the user using the operation device 105 or an information processing apparatus (e.g., a personal computer or a portable information terminal). The first image forming device 219a is an inkjet printing device and includes a first print head 219c having multiple ink nozzles. The first image forming device 219a discharges ink onto a medium passing a first image forming position P3 to print predetermined information on the medium.

The second image forming device 219b prints predetermined information on the back side of the conveyed medium under the control of the processing circuit 150. The second image forming device 219b is an inkjet printing device and includes a second print head 219d having multiple ink nozzles. The second image forming device 219b discharges ink onto the medium passing a second image forming position P4 to print predetermined information on the medium.

The image forming device 219 is not limited to an inkjet image forming device or a laser image forming device.

The medium ejecting apparatus 200 executes the medium conveying process illustrated in FIGS. 6 and 7 and the ejection control process illustrated in FIG. 10 similarly to the medium ejecting apparatus 100. However, in step S102 of FIG. 6, the profile includes the setting of resolution in image formation by the image forming device 219. In step S103, the control unit 151 sets the speed of each roller to be lower as the resolution in image formation increases, and sets the speed of each roller to be higher as the resolution in image formation decreases. In step S110, the control unit 151 controls the image forming device 219 to start image formation on the medium when the leading end of the medium reaches the image forming position of the image forming device 219. In steps S117 and S119 of FIG. 7, the control unit 151 controls the image forming device 219 to stop image formation on the medium when the trailing end of the medium passes the image forming position of the image forming device 219.

The control unit 151 controls the ejection roller 120 based on the detection result by the fourth media sensor 118 located between the conveyance roller 116 and the image forming device 219 and the skew amount of the medium. Accordingly, the medium ejecting apparatus 200 can prevent the distortion (stretching or shrinking) of the image formed on the medium due to a change in the conveyance speed of the medium during the image formation on the medium by the image forming device 219.

Further, the control unit 151 reduces the speed of the ejection roller 120 when the resolution in image formation is equal to or lower than the resolution threshold. Accordingly, the medium ejecting apparatus 100 can prevent the medium from falling from the ejection tray 104 or scattering on the ejection tray 104 by ejecting the medium at low speed while shortening medium conveyance time by conveying the medium at high speed till the medium is ejected. By contrast, the control unit 151 increases the speed of the ejection roller 120 when the resolution in image formation is higher than the resolution threshold. Accordingly, the medium ejecting apparatus 100 can prevent the occurrence of the jamming of the medium due to a medium remaining near the ejection port by ejecting the medium at high speed while reliably forming an image on the medium by conveying the medium at low speed during the image formation on the medium. Alternatively, the control unit 151 does not change but maintain the speed of the ejection roller 120 when the resolution in image formation is higher than the resolution threshold. In this case, the medium ejecting apparatus 100 can reliably form an image on the medium by conveying the medium at low speed during image formation and can prevent the medium from falling from the ejection tray 104 or scattering on the ejection tray 104 by ejecting the medium at low speed.

As described above in detail, the medium ejecting apparatus 200 controls the ejection roller 120 based on the detection result by the fourth media sensor 118 located between the conveyance roller 116 and the image forming device 219 and the skew amount of the medium. Thus, the medium ejecting apparatus 200 controls the ejection roller 120 when it is determined that the image formation on the medium is completed based on the position of the medium and the skew amount of the medium. Thus, the medium ejecting apparatus 200 can properly eject a medium while properly forming an image on the medium.

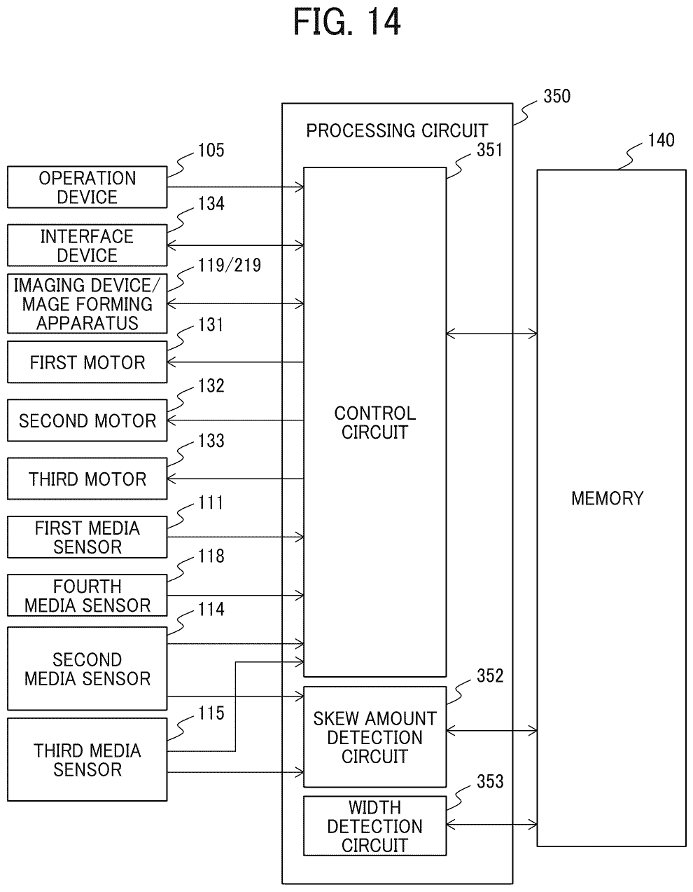

FIG. 14 is a diagram illustrating a schematic configuration of a processing circuit 350 of a medium ejecting apparatus according to still another embodiment.

The processing circuit 350 is used in place of the processing circuit 150 used in the medium ejecting apparatus 100 or 200 and executes processes including the medium conveying process and the ejection control process instead of the processing circuit 150. The processing circuit 350 includes a control circuit 351, a skew amount detection circuit 352, and a width detection circuit 353. These circuits may be implemented by independent integrated circuits, microprocessors, firmware, or a combination thereof.

The control circuit 351 is one example of circuitry and functions like the control unit 151. The control circuit 351 receives the operation signal from the operation device 105 or the interface device 134, the first media signal from the first media sensor 111, the second media signal from the second media sensor 114, the third media signal from the third media sensor 115, and the fourth media signal from the fourth media sensor 118. The control circuit 351 reads the skew amount of the medium and the width of the medium from the memory 140. The control circuit 351 controls the first motor 131, the second motor 132, and the third motor 133 based on the obtained pieces of information. The control circuit 351 generates line images from the imaging device 119 and stores the line images in the memory 140. The control circuit 351 generates an input image and outputs the input image to the interface device 134. Alternatively, the control circuit 351 controls the image forming device 219 to form an image on the medium.

The skew amount detection circuit 352 is an example of the circuitry and functions like the skew amount detection unit 152. The skew amount detection circuit 352 receives the second media signal from the second media sensor 114 and the third media signal from the third media sensor 115, or reads the line images from the memory 140. The skew amount detection circuit 352 detects the skew amount of the medium from the obtained information and stores the skew amount in the memory 140.

The width detection circuit 353 is an example of the circuitry and functions like the width detection unit 153. The width detection circuit 353 reads the line images from the memory 140. The width detection circuit 353 detects the width of the medium from the line images and stores the width in the memory 140.

As described above in detail, the medium ejecting apparatus using the processing circuit 350 can properly eject a medium while properly performing predetermined processing relative to the medium.

Embodiments of the present disclosure are not limited to the above-described embodiments. For example, the medium conveying path may be a so-called U-turn path, and the medium ejecting apparatus 100 may feed and convey media placed on the media tray sequentially from the top and eject the media to the ejection tray. In this configuration, the separation roller is located below the feed roller to face the feed roller.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A medium ejecting apparatus comprising:
a conveyance roller to convey a medium;
a processing device to perform a predetermined processing relative to the medium conveyed by the conveyance roller;
an ejection roller located downstream from the processing device in a medium ejecting direction to eject the medium subjected to the predetermined processing;
a motor to drive the conveyance roller and the ejection roller;
a first media sensor located between the conveyance roller and the processing device to detect the medium; and
circuitry configured to:
detect a skew amount of the medium; and
control the ejection roller based on a detection result by the first media sensor and the skew amount before a trailing end of the medium passes the ejection roller.

2. The medium ejecting apparatus according to claim 1,
wherein the processing device includes an imaging device including an imaging sensor, and the predetermined processing includes imaging the medium conveyed by the conveyance roller.

3. The medium ejecting apparatus according to claim 1,
wherein the processing device includes an image forming device, and the predetermined processing includes forming an image on the medium conveyed by the conveyance roller.

4. The medium ejecting apparatus according to claim 2,
wherein the circuitry is configured to detect the skew amount based on an image generated by the imaging device.

5. The medium ejecting apparatus according to claim 1, further comprising multiple second media sensors located at intervals in a direction intersecting the medium ejecting direction,
wherein the circuitry is configured to detect the skew amount based on the detection results by the multiple second media sensors.

6. The medium ejecting apparatus according to claim 1,
wherein the circuitry is configured to change a speed of the ejection roller when the skew amount is equal to or less than a skew amount threshold.

7. The medium ejecting apparatus according to claim 2,
wherein the circuitry is configured to:
reduce a speed of the ejection roller when a resolution in imaging by the imaging device is equal to or less than a resolution threshold; and
maintain or increase the speed of the ejection roller when the resolution is higher than the resolution threshold.

8. The medium ejecting apparatus according to claim 3,
wherein the circuitry is configured to:
reduce a speed of the ejection roller when a resolution in image formation by the image forming device is equal to or less than a resolution threshold; and
maintain or increase the speed of the ejection roller when the resolution is higher than the resolution threshold.

9. The medium ejecting apparatus according to claim 1,
wherein the circuitry is configured to:
change a speed of the ejection roller before a trailing end of the medium passes the ejection roller; and
return the speed of the ejection roller before a leading end of a subsequent medium reaches the conveyance roller.

10. The medium ejecting apparatus according to claim 1,
wherein the circuitry is further configured to:
detect a width of the medium; and
control the ejection roller based on the width in addition to the detection result and the skew amount.

11. The medium ejecting apparatus according to claim 1,
wherein a distance between the conveyance roller and the ejection roller in a medium ejecting direction is shorter than a minimum medium length supported by the medium ejecting apparatus.

12. A method for ejecting a medium, the method comprising:
driving a conveyance roller and an ejection roller by a motor;
conveying a medium by the conveyance roller;
detecting the medium by a media sensor located between the conveyance roller and a processing device to perform predetermined processing relative to the medium conveyed by the conveyance roller;
detecting a skew amount of the medium;
controlling the ejection roller based on a detection result of the medium and the skew amount before a trailing end of the medium passes the ejection roller; and
ejecting, by the ejection roller, the medium subjected to the predetermined processing,
wherein the ejection roller is located downstream from the processing device in a medium ejecting direction.

13. A computer-readable, non-transitory recording medium storing a computer program, wherein the computer program causes a medium ejecting apparatus to perform a process, wherein the medium ejecting apparatus includes a conveyance roller to convey a medium, a processing device to perform predetermined processing relative to the medium, an ejection roller located downstream from the processing device in a medium ejecting direction to eject the medium subjected to the predetermined processing, a motor to drive the conveyance roller and the ejection roller, and a media sensor located between the conveyance roller and the processing device to detect the medium,
the process comprising:
detecting a skew amount of the medium; and
controlling the ejection roller based on a detection result of the medium and the skew amount before a trailing end of the medium passes the ejection roller.
